(19) United States
(12) Patent Application Publication
(10) Pub. No.: US 2001/0053713 A1
(43) Pub. Date: Dec. 20, 2001

(54) Scan poker CD game

(76) Inventor: Henry J. Schultz, Erie, PA (US)

Correspondence Address: Richard C. Litman, LITMAN LAW OFFICES, LTD., P.O. Box 15035, Arlington, VA, 22215, US

(21) Appl. No.: 09/757,498

(22) Filed: Jan. 11, 2001

Related U.S. Application Data
(60) Provisional application No. 60/176,487, filed on Jan. 18, 2000.

(51) Int. Cl. A63F 13/00

(52) U.S. Cl. 463/9; 463/30; 463/35

(57) ABSTRACT

A game wherein players identify the title and/or artist of a song after listening to several notes. The apparatus has a variable number of freeze buttons, a scan continue button, a compact disk player, a logic circuit, a universal remote control, a timer and a buzzer. The disk player loads at least 3 compact disks, and has remote pause, disc skip and play functions. The scan poker CD player program charts are designed for at least 31 track programmable CD players. The method includes determining the scan operator and banker, beginning the game, correctly identifying a song, incorrectly identifying a song and terminating the game. The game continues for a player until he runs out of money, refuses to ante up or acquires a predetermined number of points. It also ends if the game is not resolved in one round, where the game is over and the scan poker operator collects the pot.

### CROSS-REFERENCE TO RELATED APPLICATION

This application claims the benefit of U.S. Provisional Patent Application Ser. No. 60/176,487, filed Jan. 18, 2000.

### BACKGROUND OF THE INVENTION

1. Field of the Invention

The present invention relates to a musical game device and method. More specifically, the invention is a musical game device and method where players compete for money and points by identifying a song after listening to several notes of the song.

2. Description of Related Art

Musical game devices and methods are well known in the related art. There are also musical game devices and methods shown on television game shows and miniature home versions, such as Concentration, Name That Tune and Jeopardy. With the application of virtual reality software and video games, the scope of musical game devices and methods today have broadened greatly. U.S. Pat. No. 4,336,935 issued to Goldfarb outlines an embodiment of an electronic game apparatus that simulates the popular game show Concentration. When the apparatus is operated in one of its game modes, a number of different songs, each having an average length of approximately ten notes, are each assigned by the apparatus at the commencement of a game to a pair of designator buttons of a provided keyboard in a random manner. For each turn of play, a player depresses a first designator button, hears at least a portion of the song assigned to that button, and then attempts to match it with the other button also assigned to that same tune by depressing a second designator button.

U.S. Pat. No. 4,372,554 issued to Orenstein outlines an electronic question and answer game that utilizes a microprocessor and cassette tape recorder. The game has a central game circuit and 4 player modules which control each player's response to one of the wide variety of games played on the cassette tape recorder. Games include a simulation of the game show Family Feud, television trivia questions and a game asking the definition of various chosen words.

U.S. Pat. No. 5,679,075 issued to Forrest et al., outlines an interactive, multi-media game apparatus and method that allows players to cooperatively solve puzzles, obtain clues and solve an overall riddle in the context of a rich narrative as they move between a prerecorded audio and/or visual plot. This apparatus and method utilizes a multi-media game that requires teams of players to collect pieces of information needed to solve an overall “meta-puzzles”, while following a prerecorded narrative.

U.S. Pat. No. 5,486,006 issued to Bruno et al., outlines a question and answer quiz game based on music themes. The game utilizes a single rolling die with temporal indicia, indicating a time period such as the 1960's, 1970's or 1980's. A set of cards are provided that state a song title and year that correspond to the time period rolled on the die, which requires a player to identify the correct artist for that song and time period. Corrected answers are worth points and players play to a predetermined number of points.

U.S. Pat. No. 4,690,025 issued to Hines et al., outlines a musical entertainment apparatus that is similar to the Name That Tune game show. Switches are provided for four players that can compete to name the correct song being played. Players of the game can stop the music when they think they have correctly identified the song being played. A score indicator is also provided. Music is generated by an apparatus that can convert coded cards into music.

The device described in U.S. Pat. No. 4,690,025 is a fun and interesting game, however, it outlines the use of an apparatus that is outdated for today's technology. What is needed is an apparatus and method that allows its users to compete to identify a song after listening to several musical notes of the song, while utilizing today's technology.

None of the above inventions and patents, taken either singly or in combination, is seen to describe the instant invention as claimed.

### SUMMARY OF THE INVENTION

The invention is a game apparatus and method in which players attempt to identify the title and/or artist of a song after listening to several notes of the played song. The apparatus is made up of a variable number of freeze buttons, a scan continue button, a compact disk player, a universal remote control, a logic circuit, a timer and a buzzer. The compact disk player has a capacity to hold and play at least 3 compact discs, have remote disc skip, play and pause functions and be at least 31 track programmable.

The method of the game consists of determining the scan operator and banker, actually beginning the game, correctly identifying a song, incorrectly identifying a song and terminating the game. The game continues until a player runs out of money, refuses to contribute an ante or reaches a predetermined number of points. If the game is not resolved in one round (number of freeze buttons being used in game determines the number of songs in one round) game is over and scan operator collects the pot. The game is designed for at least 3 players.

Accordingly, it is a principal object of the invention to provide a game in which individuals attempt to identify a song after listening to several notes of the song, using updated equipment such as a compact disk player.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a scan poker CD game according to the present invention.

FIG. 2 is a block diagram of the steps of a method of playing a scan poker CD game according to the present invention.

FIG. 3 is a listing of the steps that determine who is to be the scan operator and banker for a scan poker CD game according to the present invention.

FIG. 4 is a listing of the steps that begin a scan poker CD game according to the present invention.

FIG. 5 is a listing of the steps involved with a player giving a correct answer in a scan poker CD game according to the present invention.

FIG. 6 is a listing of the steps involved with a player giving an incorrect answer in a scan poker CD game according to the present invention.

FIG. 7 is a listing of the steps involved with the termination of a scan poker CD game according to the present invention.

FIG. 8 is a circuit diagram of a scan poker CD game according to the present invention.

Similar reference characters denote corresponding features consistently throughout the attached drawings.

### DETAILED DESCRIPTION OF THE PREFERRED EMBODIMENT

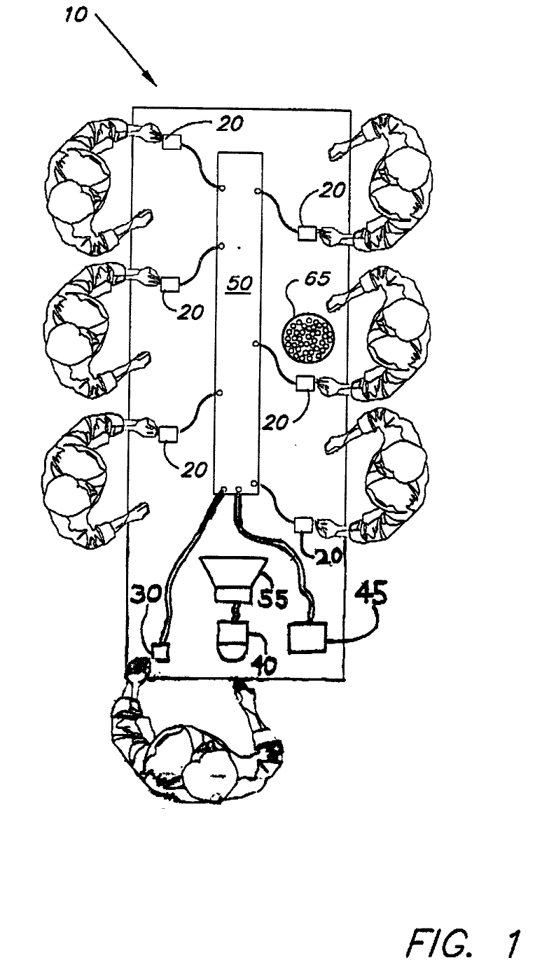

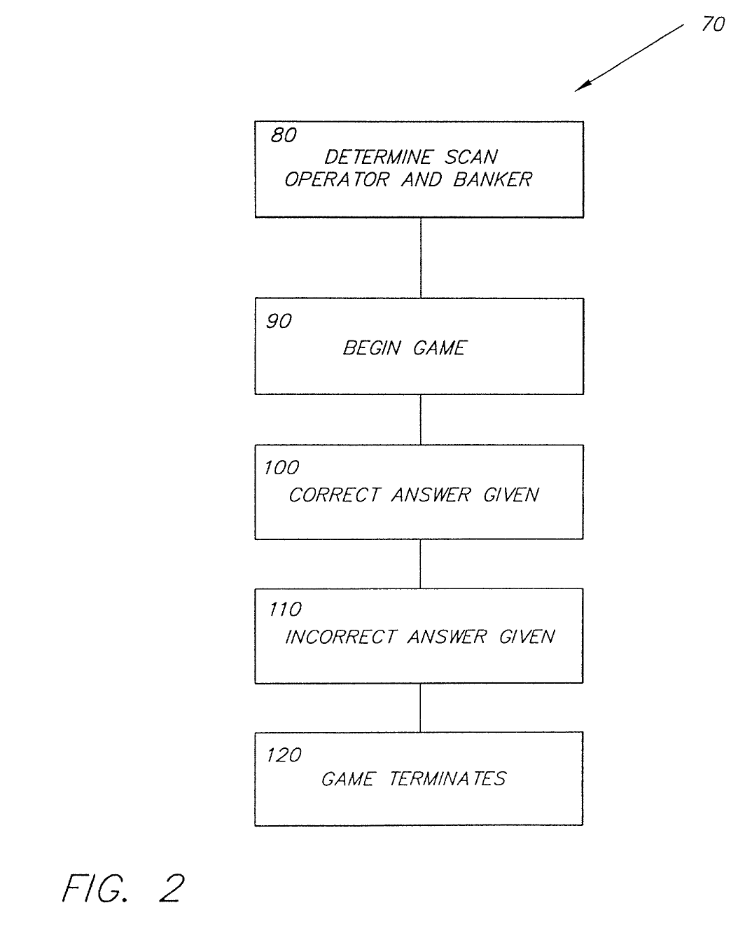

The present invention is a game apparatus and method in which players attempt and compete to identify a played song after listening to several musical notes of that song. The game apparatus 10 is comprised of a variable number of freeze buttons 20, a scan continue button 30, a compact disk player 40 and an Universal remote control 45 as depicted in FIG. 1. The method of the present invention is comprised of the five steps outlined in FIG. 2.

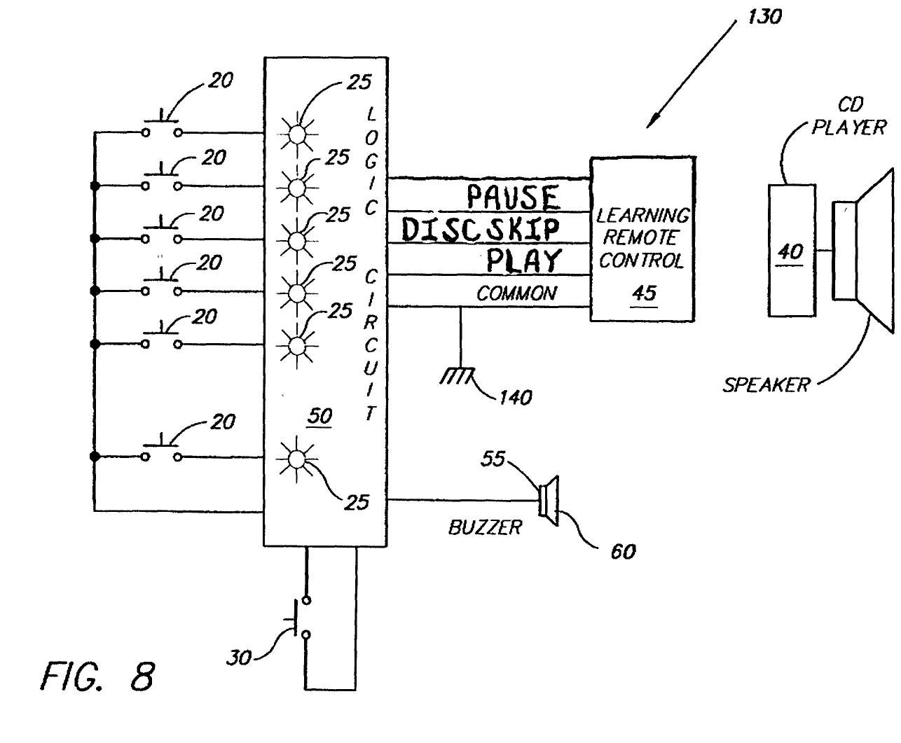

The freeze buttons 20, the scan continue button 30 and universal remote control 45 are electrically connected by a logic circuit 50. The compact disk player 40 is controlled by the universal remote control 140 (See FIG. 8). The logic circuit 50 allows the activation of a single freeze button 20 to lock out the remaining freeze buttons 20 and scan continue button 30. This is an important feature of the apparatus 10, since players compete to be the first player to correctly name the title and/or artist of a played song. The freeze button 20 that is activated first is identified by a LED (light-emitting diode) light 25 (See FIG. 8) (on) the freeze button 20.

The freeze buttons 20 also pause the compact disk 40 player when activated, allowing the player a predetermined period of 5 seconds to name the title and/or artist of a programmed song played by the compact disk player 40. A timer 55 is activated and a buzzer 60 is sounded after 5 seconds. After the buzzer 60 sounds, the scan continue button 30 is unlocked. The compact disk player 40 must have the capacity to hold and play a plurality of at least 3 compact discs and have remote pause, disc skip and play functions. The compact disc player 40 must also be at least 31 track programmable and operable via a universal remote control 140, which is operated and controlled by the logic circuit 50 during the course of a game.

The scan continue button 30 can reset and plays a second programmed song after a freeze button 20 is activated, whereby the buzzer 60 sounds and the scan continue button 30 is unlocked. The freeze buttons 20 that were previously locked out are unlocked by the scan continue button 30, which is also used to start the game.

The method 70 of the present invention is comprised of the steps outlined in FIG. 2. The method 70 for playing the game, in which players attempt and compete to identify a played song after listening to several musical notes of that song, comprise of the steps of determining a scan button operator and banker 80, beginning the game 90, giving a correct response 100 to a song i being played during the game, giving an incorrect response 110 to a song being played during the game and playing additional songs until terminating the game 120.

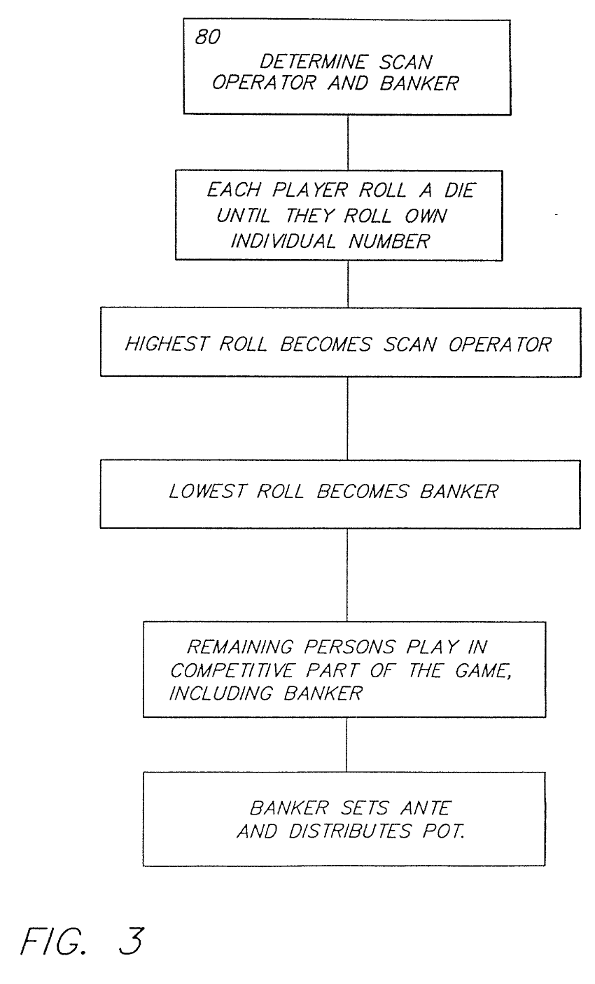

The step of determining a scan button operator and banker 80, as depicted in FIG. 3, comprises the steps of having each player roll a standard six-sided die until original number is rolled and having the player that rolls the highest number with the die to become the scan operator and having the player that rolls the lowest number with the die become the banker. The banker sets the ante and distribute winnings from a pot 65 during the course of the game. Ties are simply rolled over with an additional die until they are broken.

The scan operator controls the scan continue button 30, and is the only person that does not participate in the competitive part of the game. The scan operator is not included in the dice roll at the beginning of the next game that is played and is automatically a player in the next game without being a banker or scan operator. The scan operator is therefore not included in the dice roll at the beginning of the next game. A category is chosen by appointed Scan operator from categories available (such as Time Life rock hits of the 70's). CD player is then loaded and programmed by scan operator.

The banker, who does participate in the competitive part of the game, decides how much the ante will be and also controls the pot 65. The banker is responsible for collecting antes, dividing and distributing the pot 65 when songs are correctly identified. Winnings are rounded-up to the nearest tenth of a dollar and are computed using a basic hand calculator.

Players that wish to can drop out of the game by not giving an ante. It is recommended to play game with 3 players minimum. Freeze buttons 20 can be used individually or can be used by pairs of players to accommodate more people.

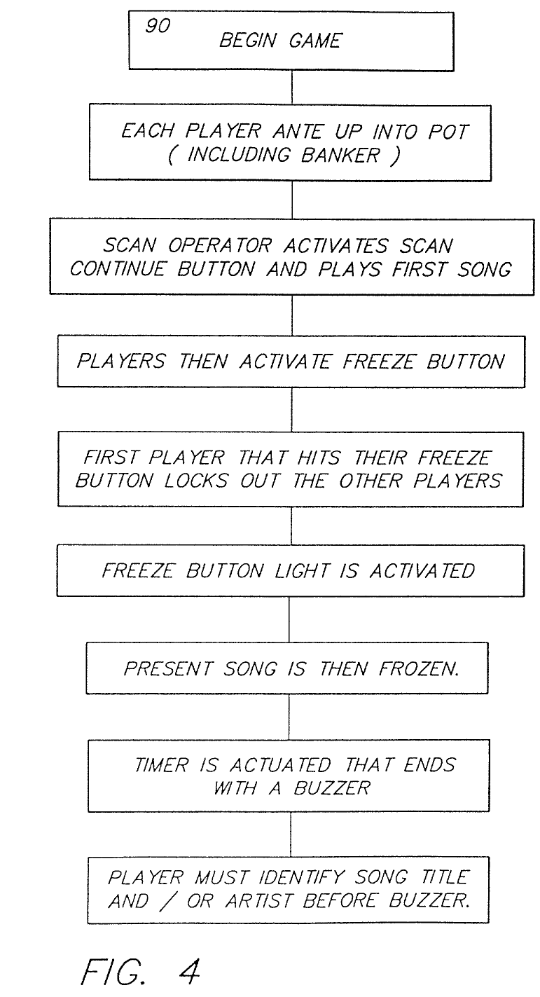

The game begins 90 by having each player playing the game to contribute a predetermined ante into a pot 65, which is determined by the banker. This is depicted in FIG. 4. After each player has contributed their ante, the scan operator activates the scan continue button 30 and plays the first song of the game. Players compete to name the title and/or artist of the song, as players activate a freeze button 20 in a response to hearing the beginning of each song.

The player that first activates his freeze button 20 in response to a song automatically locks out the remaining freeze buttons 20 and scan continue button 30. Upon activation of the freeze button 20, the LED light 25 is activated and a 5 second automatic timer 55 and buzzer 60 are also activated in response to the song. The player that activated the freeze button 20 then attempts to correctly identify the artist and title before the buzzer 55.

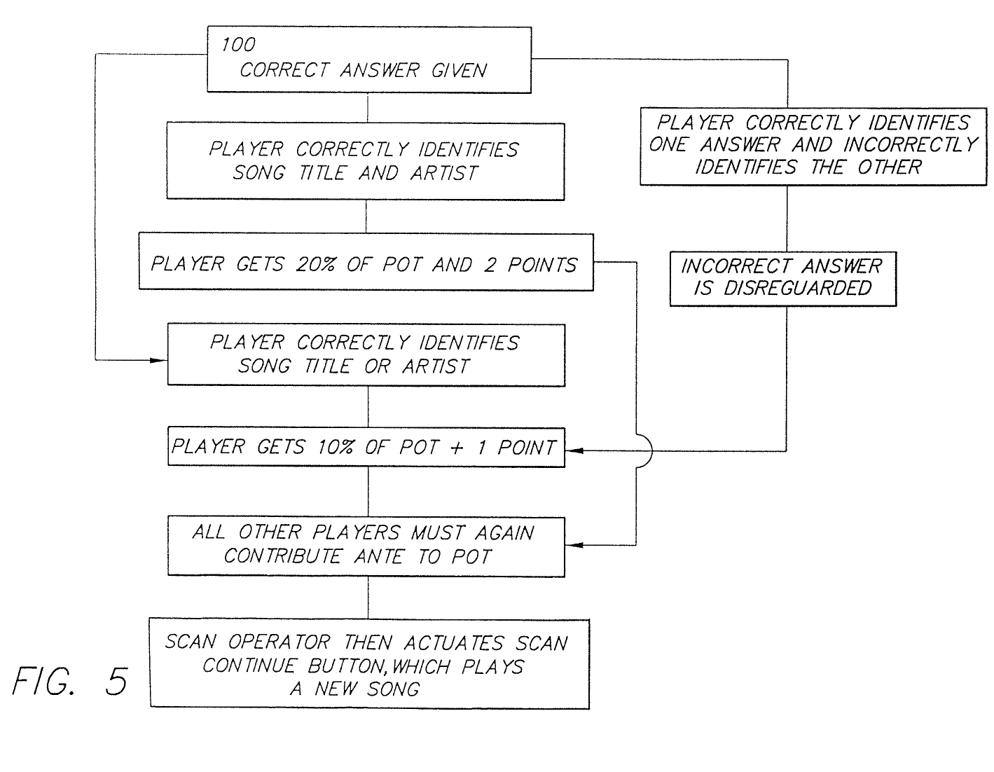

Several steps follow if the player can correctly identify a song title and/or artist of a played song 100, as shown in FIG. 5. If a player correctly identifies both the song title and artist of a song, the player will receive a predetermined percentage of 20% of the pot and 2 points for correctly naming the song title and artist of the song. If a player correctly identifies only the song title or artist of the song, that player will receive a different predetermined percentage of 10% of the pot and 1 point. After a player correctly identifies the title and or artist of a played song, the remaining players must then each contribute an additional ante into the pot 65 and the scan operator must activate the scan continue button 30 to generate a new song.

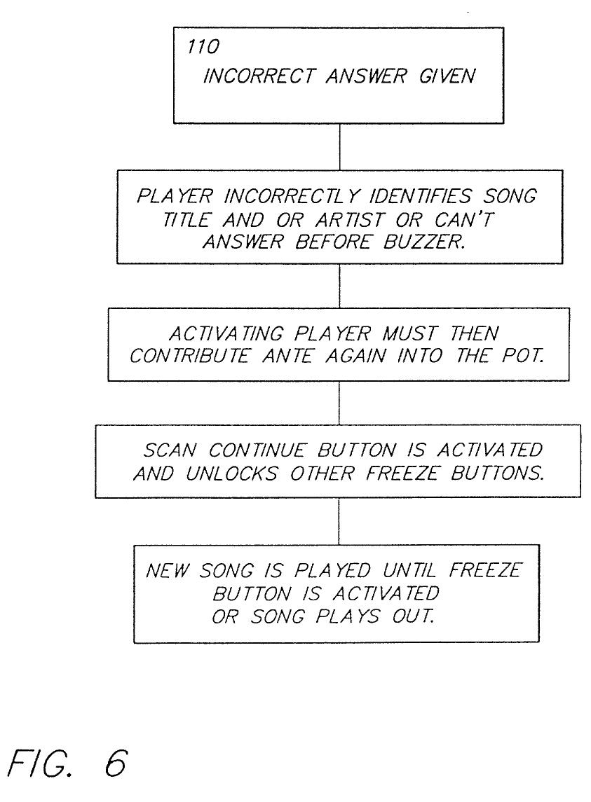

If the player incorrectly identifies a song title and artist of a played song 110 or does not respond before the buzzer 60 is activated, that player must contribute an additional ante into the pot 65. This is depicted in FIG. 6. After the buzzer 60 sounds the scan operator checks the compact disk player 40 readout, which identifies the song track and compact disk which was just played. The scan operator then finds the title and artist of the song from the cover of the compact disk that was just played. The scan operator then activates the scan continue button 30 to unlock the other freeze buttons 20 not activated in giving the incorrect answer and begins to play a new song. Note that the song that was incorrectly identified cannot be responded to again by the other players, unless it comes about again in the programmed tracks.

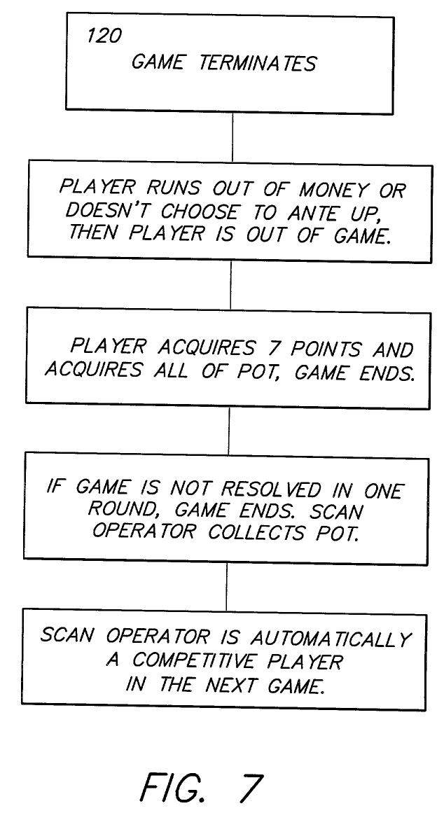

Songs continue to be played until the game is terminated 120, as shown in FIG. 7. This occurs for a player when he runs out of money and is not able to continue the game or refuses to contribute an ante. This also occurs after a player acquires a predetermined number of points and is then given all of the money built-up in the pot 65, thereby ending the game. If game is not resolved in one round, game ends and scan operator collects pot 65.

FIG. 8 depicts a circuit diagram 130 of the scan poker CD game apparatus 10 according to the present invention. There are a plurality of switches which constitute the freeze buttons 20, which are tied together electrically with the scan continue button 30, buzzer 60, timer 55 and Universal remote control 45 by the logic circuit 50. The compact disk player 40 is also part of the game apparatus 10 and is controlled by the universal remote control 140.

It is to be understood that the present invention is not limited to the sole embodiment described above, but encompasses any and all embodiments within the scope of the following claims.

I claim:

1. A game apparatus in which players attempt and compete to identify a played song after listening to several musical notes of that song, comprising:
A compact disk player and a universal remote control therefore;
a plurality of freeze buttons, wherein one of which sequentially and electronically lock out the remaining freeze buttons and scan continue button;
a LED light on each said freeze button that is activated when the freeze button is activated;
a scan continue button, which is used to reset said freeze buttons after their use and to start a game;
said compact disk player configured to play a plurality compact disks having a variety of songs recorded thereon, the compact disk player further comprising a means for programming songs and have remote control pause, play and disc skip functions; and
a logic circuit wherein the freeze buttons, the scan continue button and the universal remote control are electrically connected thereto.

2. A game apparatus according to claim 1, wherein the freeze buttons are configured to pause the compact disk player when activated, engage the LED light, begin timer for a predetermined period and then activate a buzzer.

3. A game apparatus according to claim 2, wherein the scan continue button can play a second song after the buzzer sounds and scan continue button is unlocked.

4. A method for playing a game, in which players attempt and compete to identify a played song after listening to several musical notes of the song, comprising the steps of:
(a) determining a scan button operator and banker;
(b) beginning to play the game;
(c) giving a correct response to the song being played;
(d) giving an incorrect response to the song being played; and
(e) playing additional songs until terminating the game.

5. A method for playing a game according to claim 4, wherein said determining step (a) further comprises the steps of:
(1) having each player roll a standard six sided die;
(2) having a player that rolls the highest number with the die become the scan operator;
(3) having the player that rolls the lowest number with the die becoming the banker; and
(4) having the banker set an ante and distribute winnings from a pot during the course of the game.

6. A method of playing a game according to claim 4, wherein said beginning step (b) further comprises the steps of;
(1) having each player playing the game contribute a predetermined ante into a pot;
(2) having the scan operator activate the scan continue button and play a song;
(3) having a player activate a freeze button in a response to the song;
(4) activating an automatic timer, LED light and a buzzer in response to said song; and
(5) having a player attempt to identify the song and title before the buzzer.

7. A method of playing a game according to claim 4, wherein said step (c) of correctly giving an answer comprises the steps of;
(1) having a player correctly identify the song title and artist of the song;
(2) having a player receive a predetermined percentage of the pot and 2 points for correctly naming a song title and artist of the song;
(3) having a player correctly identify only the song title or artist of the song;
(4) having a player receive another predetermined percentage of the pot and 1 point;
(5) having all other players contributing an additional ante into the pot; and
(6) having the scan operator activate the scan continue button to generate a new song after the buzzer sounds and scan continue button is unlocked.

8. A method of playing a game according to claim 4, wherein said step (d) of giving an incorrect answer further comprises the steps of;
(1) having a player incorrectly identify a song title and an artist of a played song and not respond before the buzzer is activated;
(2) having that player contribute an additional ante into the reset pot; and
(3) having the scan operator activate the scan continue button to unlock the other freeze buttons not activated in giving the incorrect answer and to play a new song.

9. A method of playing a game according to claim 4, wherein said step (e) further comprises the steps of:
(1) having a player run out of money or simply refusing to contribute an ante and ending the game for that player;
(2) having a player acquiring a predetermined number of points and acquiring all of the pot; and
(3) having the number of scan buttons being used determine the number of songs in one round, whereby game is over and the scan operator collects what is in the pot.
